(19) United States
(12) Patent Application Publication
(10) Pub. No.: US 2008/0152781 A1
(43) Pub. Date: Jun. 26, 2008

(54) Wheat Materials and Related Methods

(76) Inventor: Patrick C. Dreese, Plymouth, MN (US)

Correspondence Address: GENERAL MILLS, INC., P.O. BOX 1113, MINNEAPOLIS, MN, 55440, US

(21) Appl. No.: 11/568,735

(22) PCT Filed: May 5, 2005
(86) PCT No.: PCT/US2005/015738

§ 371 Date: Aug. 20, 2007

Related U.S. Application Data
(60) Provisional application No. 60/569,938, filed on May 11, 2004.

(51) Int. Cl. A23L 1/172; A23L 1/10

(52) U.S. Cl. 426/622; 426/618

(57) ABSTRACT

Described are methods of treating wheat materials, including reducing the amount of active enzymes in a wheat material by treating with steam; as well as wheat flour, dough, and other compositions and food ingredients prepared from the treated wheat material.

### FIELD OF THE INVENTION

The invention relates to methods of processing wheat materials; to processed wheat materials such as wheat grain, sprouting wheat grain, wheat flour, germ, bran, endosperm, etc.; to wheat materials for use in food products such as doughs; and to related methods involving the preparation and use of the wheat materials, and food ingredients and compositions, wherein processing a wheat material includes treatment with steam to deactivate enzymes.

### BACKGROUND OF THE INVENTION

Wheat grain and wheat grain derivatives are used in a multitude of food products including white and whole-wheat flour, wheat bran, wheat germ, etc., as well as food products that contain wheat materials, such as doughs and breads. As one example, flour from wheat grain can be used to prepare dough products, because gluten found in wheat flour can produce a dough that has stiffness and elasticity properties that allow for desired texture and leavening.

To prepare a food product that contains a wheat material, wheat grain is typically processed by milling to produce a flour, optionally also by steps of separating milled wheat grain into portions such as flour (mainly endosperm) and non-flour portions, the non-flour portion including wheat germ and wheat bran. Other processing steps may include preparation steps such as a step to clean or wash harvested wheat grain, a drying step, optionally a tempering step to effect a desired moisture content of wheat grain, and separating milled wheat material into multiple streams.

### SUMMARY OF THE INVENTION

Wheat grain (e.g., in the form of kernels) includes active enzymes that can produce spoilage in food ingredients and food products prepared from the wheat grain. The enzymes are contained throughout the wheat grain, within different parts of the grain or “kernel.” An individual wheat grain or kernel includes three major portions referred to as the germ, the bran, and the endosperm. Enzymes are significantly more concentrated in the wheat germ and wheat bran portions of a wheat kernel, and are less concentrated in the much larger endosperm, to the extent that most of the total amount of enzymes in a wheat kernel is in the germ and bran, even though the germ and bran make up only a minority of the total wheat kernel.

Wheat grain also includes proteins, which are desirable in food products for their nutritional value and for their ability to provide mechanical properties to food products, e.g., as gluten in doughs and breads. Gluten is just one type of protein found in wheat grain. Gluten gives a dough composition an elastic rheology, which can produce a desired texture and facilitate leavening by containing a leavening gas in an elastic dough matrix, while allowing a dough matrix to expand without breaking. This property is particularly important for producing doughs referred to as “developed” doughs, which are relatively stiff and elastic doughs used for preparing breads, rolls, pizza crusts, bagels, pretzels, etc. The different portions of wheat grain all contain some protein, e.g., gluten and non-gluten proteins. Gluten protein, however, is relatively concentrated in the endosperm, while the germ and bran portions include only insubstantial amounts of gluten. Exposure of gluten in a wheat material to heat processing can damage the gluten and cause the gluten to lose the ability to provide desired mechanical properties, e.g., desired rheology.

According to the invention, a wheat material is treated by contacting the material with steam to deactivate enzymes. A wheat material may be wheat grain or any material derived from wheat grain, such as: wheat grain itself (i.e., wheat “kernels” or “berries”) which may be of a mill quality, sprouting, or otherwise; a material made up of a high percentage (e.g., majority) of a portion of wheat grain such as a high percentage of endosperm, wheat germ, or wheat bran, any of which may optionally be ground or milled; mixtures of portions of wheat grain; a milled wheat flour such as white flour or whole-wheat flour; etc.

Wheat material can be exposed directly to steam, of a temperature, amount, and for a period of time, that in combination are effective to reduce the amount of active enzyme contained in the wheat material. A useful reduction in the amount of active enzyme can be deactivation of an amount of original active enzymes to result in improved shelf life of the wheat material or a food ingredient or food product prepared from the wheat material. A useful degree of enzyme deactivation can be deactivation of as little as 30 percent of the original active enzymes present in a wheat material (as measured in terms of active peroxidase), or even lower, but processes according to the invention can achieve higher levels of deactivation, e.g., deactivation of at least 50 percent, 60 percent, 70 percent, or more, of the original active enzymes in a wheat material (e.g., as measured in terms of active peroxidase), depending on the particular process and wheat material.

Also according to certain embodiments of the invention, a process of using steam to deactivate enzymes in a wheat material may exhibit greater effectiveness when the wheat material being treated has a moisture content on the high end of typical moisture contents, such as greater than 10 percent moisture by weight, e.g., from 11 to about 16 weight percent moisture.

Embodiments of the invention also relate to deactivating enzymes of a wheat material while reducing or minimizing damage to gluten contained in a wheat material, for materials that contain a significant amount of gluten. Functionally speaking, and in general terms, an amount of gluten that may be considered to be a “significant” amount of gluten can be an amount of gluten that would be worth preventing damage to while processing the wheat material to deactivate enzymes. A lower limit may be down to about 2.5 or 3 percent by weight gluten based on a total amount of wheat material being processed as described herein. Examples of wheat materials that often contain at least 2.5 or 3 percent by weight gluten include materials that contain at least 20 percent by weight endosperm, including: wheat grain (i.e., wheat kernels that include the endosperm, bran, and germ); a white flour containing endosperm and low amounts of bran and germ; whole-wheat flour that contains endosperm as well as amounts of bran and germ; and combinations of any of these or other food products, wheat materials, or food ingredients that contain 20 percent by weight, 25 percent by weight, or 50 percent by weight or more of endosperm. Examples of wheat materials that are not considered to contain a significant amount of gluten include wheat germ, wheat bran, and combinations of these, optionally including a minority amount of endosperm, e.g., less than 20 percent by weight endosperm.

According to various embodiments of the invention, a wheat material processed according to the present description either may or may not include a significant amount of endosperm, and therefore may or may not contain a significant amount of gluten.

Processes of the invention that treat a wheat material that contains endosperm, and therefore some amount of gluten, can expose such a wheat material to an amount of steam, at a temperature, and for an amount of time, that deactivates enzyme but that also can reduce or minimize damage to the gluten. An example of such a treatment can be sufficient to inactivate at least 30 percent of peroxidase enzyme originally found in the wheat material, while preventing damage to a useful amount of gluten.

Processes of the invention for treating a wheat material that does not include a significant amount of gluten, e.g., wherein the wheat material does not include a significant amount of endosperm, e.g., less than 20 percent by weight endosperm, or less than 3 or 2.5 percent by weight gluten, can be performed at conditions effective to inactivate enzymes, but are not required to prevent, avoid, or reduce damage to gluten. These processes can allow a wheat material to be exposed to one or more of a higher steam temperature, a higher amount of steam, or can allow exposure for a longer period of time, allowing for increased deactivation of enzymes.

A wheat material that has been processed as described, to reduce active enzymes, can be used to produce food ingredients and food products such as flour, dough, and bread products, including refrigerated whole wheat or non-whole wheat dough products. Such food products will contain a reduced amount of active enzymes and as such can exhibit improved shelf life, e.g., improved refrigerated shelf life, and in certain embodiments of the invention can also contain useful and desired amounts of undamaged gluten.

According to the present description, the term “whole-wheat,” as it refers to whole-wheat flour, refers generally to compositions derived from wheat grain, wherein constituents of wheat grain are used in approximately the same amounts as occur naturally. Often, such flours and compositions are able to be labeled and sold as a “whole-wheat” type of product. An example of a whole-wheat flour is a flour as defined in United States Code Title 21, Chapter I, Part 137, Subpart B, Section 137.200—Whole wheat flour—which states, in part, that “whole-wheat flour” is prepared by grinding cleaned wheat, wherein “the proportions of natural constituents of such wheat, other than moisture, remain unaltered.” Another example of a whole-wheat flour is a flour according to the Health Canada definition of whole-wheat, at B.13.005[S], which states in part that Whole wheat flour or Entire wheat flour shall be prepared by grinding and bolting cleaned, milling grades of wheat from which a part of the outer bran or epidermis layer may have been separated, and shall contain the natural constituents of the wheat berry to the extent of not less than 95 percent of the total weight of the wheat from which it is milled.

The term “whole-wheat,” as it refers to food compositions, refers generally to food compositions that contain a whole-wheat flour as an ingredient.

An aspect of the invention relates to methods of processing a wheat material. The methods include: providing a wheat material that contains endosperm and active enzyme, and treating the wheat material by contact with steam to deactivate enzymes without substantially damaging gluten of the endosperm.

Another aspect of the invention relates to methods of processing wheat material. The methods include providing wheat material that contains active enzyme, and treating the wheat material with steam to deactivate enzymes.

Still another aspect of the invention relates to methods of processing wheat material. The methods include providing a wheat material that includes greater than 10 percent by weight moisture, and contacting the wheat material with from 0.05 to 0.2 pounds of steam per pound of wheat material, the steam being at approximately atmospheric pressure.

Another aspect of the invention relates to low enzyme whole-wheat flours that contain less than 4000 units active peroxidase per gram.

Still another aspect of the invention relates to low enzyme white wheat flours that contain less than 250 units active peroxidase per gram.

Still another aspect of the invention relates to low enzyme straight-grade white wheat flours that contain less than 350 units active peroxidase per gram.

Still another aspect of the invention relates to dough compositions that include a low enzyme whole wheat flour, the flour containing less than 4000 units per gram active peroxidase.

Still another aspect of the invention relates to dough compositions that contain a low enzyme straight-grade white flour that contains less than 350 units per gram active peroxidase.

### DETAILED DESCRIPTION

The invention involves processes to deactivate enzymes of a wheat material that is, contains, or is derived from wheat grain. The wheat material may contain or be derived from one or a combination of two or more different types of wheat grains, as desired, including high or low protein-containing wheat grains and derivatives. The particular grain or combination of grains can be selected based on a variety of factors, e.g., relating to the desired product to be produced, economics, availability, etc. Non-limiting examples of types of wheat grains include Common Wheat, (Triticum vulgare), Durum Wheat (T. durum) and Club Wheat (T. Compactum).

A wheat grain (or “berry” or “kernel”) generally includes an outer bran layer, an inner endosperm, and an inner germ. A majority of wheat grain is the starchy endosperm, typically accounting for up to about 82 to 83 weight percent of the wheat grain. The endosperm contains relatively low amounts of enzymes compared to the wheat bran and wheat germ, and relatively higher amounts of gluten.

Approximately 2 to 3 (e.g., 2.5) weight percent of wheat grain can normally be wheat germ, which is known to be the germinating section of a wheat grain. The wheat germ contains relatively high concentrations of enzymes compared to the endosperm. Also, the wheat germ portion of a wheat kernel contains essentially no gluten-type protein.

An outer layer of a wheat grain is a wheat bran or seed coat layer. Typically, the wheat bran makes up approximately 14 to 15 weight percent of a wheat grain. The wheat bran also contains relatively high concentrations of enzymes compared to the endosperm. Also, the wheat bran portion of a wheat kernel contains essentially no gluten-type protein.

In general, the amount of total gluten and non-gluten protein in any type of wheat grain can vary considerably, e.g., in the general range from 7 to 17 weight percent total protein. Some soft wheats, for instance, can contain a total amount of protein in the range from 7 to 9 percent by weight protein, including gluten and non-protein type protein. High protein bread wheat can contain an amount of total protein in the range from 15 to 16 percent by weight protein, including gluten and non-gluten proteins.

Of these amounts of total protein in various types of wheat grain, a good majority of total gluten and non-gluten proteins are in the endosperm. As a general rule of thumb, the percentage of the endosperm portion of a wheat grain that is protein is often approximated as one percentage less than the percentage of protein of the entire wheat grain, i.e., if wheat grain contains 17 weight percent protein, the endosperm can be approximated to contain about 16 weight percent total (gluten and non-gluten) protein. Also as a rule of thumb, about 90 percent of the total endosperm protein is normally gluten, and only about 10 percent is non-gluten protein. Thus, in general, endosperm may contain from about 6 to about 16 percent by weight total protein, and from about 5 to about 15 percent by weight gluten.

The endosperm, bran, and germ portions of a wheat kernel contain various amounts and concentrations of enzymes. The enzymes can include a large variety of different active enzymes, including peroxidase, xylanase, protease, amylase, polyphenyl oxidase, phosphatase, lipase, and lipoxygenase.

While many different enzymes are present in wheat grain, enzyme levels of wheat grain and wheat grain constituents are often measured in terms of the enzyme peroxidase. Peroxidase is only one of many enzymes typically present in a wheat material, and may not be the most important enzyme with respect to retained freshness of a flour, dough product, or other food product prepared from a wheat material. Peroxidase, however, may be reliably measured by analytical techniques such as the one described later in this description. Also, peroxidase is relatively robust compared to some other enzymes present in wheat materials, meaning that peroxidase can be relatively more heat-stable and difficult to deactivate compared to such other, less robust enzyme species. As such, when measuring deactivation of enzymes of wheat materials, e.g., according to methods of the invention, an indication of peroxidase deactivation can also be an indication that other less heat-stable enzymes have been deactivated.

A typical amount of peroxidase that may be found in wheat grain (e.g., a kernel or other wheat material that contains naturally occurring proportions of endosperm, germ, and bran) can be in the range from 4000 to 6000 units of active peroxidase per gram wheat grain, e.g., from 4600 to 5000 units of active peroxides per gram, often about 4800 units of active peroxidase per gram (e.g., on an “as is” moisture basis”). (Within the present description and claims, moisture basis is “as is” unless otherwise specifically noted.) Of this total amount of peroxidase (and enzymes generally), different portions of a wheat grain will contain different concentrations and different total amounts of peroxidase (and enzymes generally), with relatively lower concentrations being present in the endosperm and higher concentrations being present in wheat germ and wheat bran. Typically, endosperm can include a concentration of peroxidase in the range from 500 to 700 units active peroxidase per gram endosperm (on an “as is” basis); the balance of the wheat grain, including wheat germ and wheat bran, can include a total concentration of peroxidase in the range of up to 30,000 units peroxidase per gram (on an “as is” basis).

As for gluten, the gluten content of a wheat material can be measured by known analytical techniques. One example of a useful technique is by use of a machine called a “Glutomatic.” To measure gluten content, e.g., of flour, a Glutomatic washes the starch and solubles out of the material. What is left after washing is an elastic mass of wet gluten. This gluten can be dried and weighed to determine how much gluten was in the original material. Alternatively, gluten can be measured by using electrophoresis to separate proteins. Electrophoresis can determine the percent of the total protein that is gluten. The total protein can then be measured with a nitrogen measurement technique that is used to measure all proteins.

A typical amount of gluten that may be found in a wheat kernel, and wheat grain (including natural amounts of endosperm, germ, and bran), can be up to about 12 weight percent gluten per gram of total wheat grain, e.g., from about 4 to 12 weight percent gluten per gram wheat grain. Of this total amount of gluten, essentially all of the gluten is normally contained in the endosperm, while the wheat germ and wheat bran portions of a wheat kernel contain essentially no gluten-type protein.

Wheat grain, endosperm, wheat germ, and wheat bran, can have a moisture content over a large range depending on the stage of processing, atmosphere, processing and storage history, etc. To be stable for normal storage, wheat grain should have a moisture content of below 15 percent by weight (e.g., less than 14 percent by weight), e.g., in the range from about 10 to about 12 percent by weight. At dry conditions, wheat grain may have a moisture content below this range, e.g., from 6 to 8 weight percent. For use in various milling processes, wheat grain can be tempered at from 8 to 16 hours prior to milling, to add water to wheat grain so that the moisture content is in the range from 15 to 16 weight percent when the wheat is milled.

A wheat material for use according to the invention can be any type of a wheat grain or a derivative of a wheat grain, such as a wheat grain (e.g., mill quality wheat grain, sprouting wheat grain, etc.) or portion of a wheat grain (e.g., wheat endosperm, wheat bran, or wheat germ), or a combination of two or more of these. The material may be milled, unmilled, or otherwise processed by known methods of processing wheat grain into its constituent parts, e.g., by milling and separation methods. For example, a wheat material may be a very coarse material such as wheat grain in the form of cleaned, mill-quality or sprouting wheat grain. Alternatively, a wheat material may be a fine or coarse product of a wheat milling process. An example of a finely milled product is a white flour product, which can normally be substantially composed of endosperm. Coarse milling products include materials made up of wheat germ, wheat bran, or mixtures of two or more of wheat germ, wheat bran, and a minority amount of endosperm (e.g., up to about 20 weight percent). Whole-wheat flour may be a mixture of the different wheat portions, after milling, including fine-ground endosperm combined with naturally-occurring amounts of wheat bran and wheat germ.

Various amounts of enzymes (e.g., measured in terms of peroxidase), protein, and moisture, can be contained in any particular wheat material, depending on the type of wheat material and its processing history, e.g., the type of wheat grain and whether the wheat material is substantially endosperm, bran, or germ; whether the wheat material comes from a high protein or a low protein type of wheat grain; and, moisture content of a wheat material can depend on whether a wheat material has been stored under wet or dry conditions, has been dried, or has been tempered or otherwise processed to affect moisture content; etc.

According to certain embodiments of the invention, wheat materials may or may not contain gluten. Wheat materials that contain a significant portion of endosperm, e.g., at least 20 percent by weight or more, can contain gluten, e.g., from 2.5 or 3 to 15 percent by weight gluten. Other wheat materials, e.g., those that contain less than 20 percent by weight endosperm, can either contain essentially no gluten at all or may contain only an insubstantial amount of gluten, e.g., less than 2 or 3 percent by weight gluten.

Moisture content of a wheat material can be similar to the moisture content generally possible for wheat grain, e.g., up to about 16 percent by weight. According to certain embodiments, moisture content of a wheat material can be in a range that results in improved effectiveness of enzyme deactivation by exposure to steam. The range of moisture content that can improve effectiveness of enzyme deactivation, can be a range at the higher end of the general moisture content range, for example a moisture content greater than 10 percent, e.g., in the range from about 11 to 16 percent by weight, or from 12 to 15 percent by weight.

One example of a wheat material that can be processed according to the invention is mill-quality wheat grain. Mill-quality wheat grains (e.g., in the form of kernels) are commercially available and can be prepared by de-husking, cleaning, and otherwise processing harvested wheat. The wheat grain can contain amounts of gluten and enzymes as described elsewhere herein, and can also have a moisture content that is within described ranges. For example, a mill-quality wheat grain can have a gluten content in the range up to about 12 weight percent gluten per gram of total wheat grain, e.g., from about 4 to 12 weight percent gluten per gram wheat grain; and an enzyme content as measured by peroxidase in the range from 4000 to 6000 units peroxidase per gram wheat grain. Mill-quality wheat grain can have a moisture content that depends on factors such as storage and processing history.

Additionally, the invention can advantageously be applied to material known as “sprouting wheat.” Wheat grain, if either exposed to unusually wet weather or wet storage conditions, may begin to sprout (e.g., on the stalk or when placed in storage). While a visible sprout does not necessarily form, the biological process of sprouting induces an increase in enzyme concentration within the wheat material, particularly an increase in the amount of the enzyme amylase. The increased level of amylase can be detrimental to the usefulness of the wheat grain, because amylase can cause a dough produced from the wheat grain to be excessively sticky or to produce bread having reduced volume. Thus, sprouting wheat is often not able to be used in relatively high value food applications such as in flour for dough products, but is instead often used for lower value applications such as animal feed. According to the invention, sprouting wheat can be processed by exposure to steam, to reduce the amount of enzymes (e.g., amylase) to produce a wheat grain or wheat grain derivative that is useful in preparing a dough or bread product.

Another example of a wheat material that can be processed according to the invention can be a milled wheat material (e.g., coarse, fine, or partially-milled material), such as milled wheat bran, milled wheat germ, milled endosperm, or a combination of these. See, for example, Assignee's copending U.S. patent application Ser. No. 60/569,992, entitled “FLOUR AND DOUGH COMPOSITIONS AND RELATED METHODS,” incorporated herein by reference. A milled wheat material may include one, two, or all three of these portions of wheat grain. The amounts of gluten and enzymes that will be present in a milled wheat material can depend on the relative amounts of bran, endosperm, and germ contained therein, because each of these portions of wheat grain can include different amounts of enzymes and protein. A milled wheat material that contains endosperm will contain at least some gluten, while milled wheat materials that do not contain any endosperm will contain less than a substantial amount of gluten. Moisture content of a milled wheat material will depend on the moisture content of original materials combined to produce such a wheat material, and can preferably be in a range that improves the efficiency of enzyme denaturization.

Useful examples of processes for preparing a milled wheat material will be understood by the skilled artisan to include steps of milling and separating, along with related process steps, as are presently known or developed in the future. According to exemplary such methods, mill-quality wheat grain can be processed by milling steps that may include one or more of bran removal such as pearling, pearling to remove germ, other forms of abrading, grinding, sizing, tempering, etc.

Milling processes can produce multiple streams of wheat materials, including: a flour portion that is mostly endosperm; and a bran portion that contains substantially the balance of wheat grain components, which will be substantially wheat germ and wheat bran and typically not more than about 20 percent by weight endosperm. The amount of flour portion based on total milled wheat grain may often be an amount in the range from about 65 to about 85 weight percent flour portion, e.g., from about 70 to about 80 weight percent flour portion. The flour portion is the portion of flour normally used in preparing non-whole-wheat flour, e.g., processed white flour. The flour portion typically will contain a large percentage of endosperm, e.g., greater than 90, 95, or 99 weight percent endosperm, based on the total weight of the flour portion, and can also normally contain relatively low amounts of wheat bran and wheat germ, e.g., less than 20, 10, 5, 2, or 1 weight percent total wheat bran and wheat germ, based on the total weight of the flour portion.

A flour portion of a milled wheat grain, as is often basis for a white wheat flour product, will include enzymes in concentrations similar to concentrations of enzymes in the endosperm of wheat grain. This can result in a flour portion that includes peroxidase enzyme in an amount, for example, from between 600 to 2000 units active peroxidase per gram of the flour portion. Such a flour portion, being high in endosperm, also is relatively high in gluten, with the amount of gluten depending on the original gluten content of the wheat grain from which the flour portion was milled, and the amount of non-endosperm wheat portions (bran and germ) contained in the flour portion. As a single example, a flour portion of a milled wheat grain that contains about 99 weight percent endosperm and about 1 percent total bran and germ, may contain gluten an amount in the range from about 5 to about 15 percent by weight gluten. A flour portion of a milled wheat grain that contains a higher amount of bran or germ can contain a correspondingly lower amount of gluten.

According to terminology used herein, milled wheat grain may also produce a bran portion that contains the constituents of the milled wheat grain that are not included in the flour portion. The “bran” portion contains mostly wheat bran and wheat germ, but normally will also contain some minority amount of endosperm (e.g., less than 20 percent endosperm by weight based on the total amount of bran portion.)

The concentrations of enzymes in the majority constituents of a bran portion (wheat germ and wheat bran) are relatively high compared to the concentrations of enzymes in the majority constituent of the flour portion (endosperm). Thus, the concentrations of enzymes in a bran portion of milled wheat grain will normally be higher than the concentrations of enzymes in the flour portion. For example, in terms of the enzyme peroxidase, a bran portion made up of substantially wheat bran and wheat germ, and very little endosperm, may contain up to 30,000 units active peroxidase per gram (on an “as is” basis).

The concentration of gluten in a bran portion of a milled wheat grain will depend greatly on the amount of endosperm in the bran portion. A bran portion that contains little or no endosperm will contain no more than an insubstantial amount of gluten. As an example, a bran portion of milled wheat grain that contain up to 20 weight percent endosperm, may normally contain no more than about 3 weight percent gluten, e.g., less than about 2.5 weight percent gluten, which amounts are considered to be insubstantial amounts of gluten for purposes of the present description.

A bran portion of milled wheat grain may be handled or processed as a single material or material stream, or may be separated into different sub-portions of milled wheat materials, any of which can be processed as described herein with steam to deactivate enzymes. Whether a bran portion is separated, and if so into what sub-portions, can be based on factors such as utility, convenience, economic considerations, or any other bases of preference. A bran portion may be separated into any variety of useful sub-portions that may include portions sometimes referred to as “midds” or “shorts,” “germ,” and “bran.” Alternate sub-portions may be referred to as fine bran and coarse bran.

According to the invention, a wheat material such as a wheat grain or a milled wheat material can be treated with steam to deactivate enzymes. The steam can be at a temperature, and can contact the wheat material for an amount of time, and in an amount, that in combination can be effective to deactivate a useful or desired amount of enzymes in the wheat material.

A useful amount of time and a useful steam temperature for processing any particular type of wheat material can depend on factors such as one or more of: the type of wheat material, its size (e.g., coarseness), its moisture content, original enzyme content, original gluten content, and the amount of enzyme deactivation desired. A useful amount of steam (of a given temperature) can be an amount that provides sufficient energy to inactivate an amount of enzymes as described herein. For relatively coarse wheat materials such as wheat grain or coarsely milled wheat materials, a relatively longer exposure time may be required compared to exposure time used for relatively finer materials such as a wheat flour composition or other finely milled material.

As general exemplary processing conditions, steam for deactivating enzymes in a wheat material may be any form of steam, such as standard steam, superheated steam, pressurized steam, or atmospheric steam having a temperature of approximately 100 C (212 F) (depending on altitude). The time of exposure of a material to an amount of steam can be any effective amount of time, such as a fraction of a seconds, a number of seconds or minutes, up to 30 minutes or an hour if needed or desired. The amount of time required may depend on many factors, especially relating to the process and equipment used to contact the wheat material with the steam, including whether agitation is used or whether the process is continuous or a batch process. For automated, high speed or high volume processes, a residence time of a wheat material (exposure time to steam) in contact with a particular amount of steam can be at the low end of the above exemplary range, e.g., a matter of seconds or less than a second. Also, generally speaking, relatively finely-ground materials can be exposed to steam within the low end of this range, e.g., for a matter of seconds or less than a second. For relatively coarse wheat materials such as wheat grain and coarse milled materials, a relatively longer exposure time may be required compared to the exposure time for relatively finer materials such as flour composition.

Another factor of the inventive process can be the amount of steam at a given temperature to which a wheat material is exposed. The amount of steam, e.g., by weight or volume, per weight or volume of a wheat material, can be an amount that for a given temperature and period of exposure can deactivate a useful amount of enzymes, optionally without damaging a desired amount of gluten. A useful amount of steam can depend on factors such as the type of wheat material and the gluten, enzyme, and moisture contents of the wheat material. A general exemplary range of a useful amounts of steam (e.g., for exposure times in the range from a fraction of a second to a half hour), using steam at atmospheric pressure having a temperature in the neighborhood of 100 C (212 F), can be amounts in the range from 0.05 to 0.5 pound of steam per pound of wheat material. More specifically, for steam treating wheat materials that contain a significant amount of gluten, to reduce the amount of damage to the gluten, steam can be used in an amount in the range from 0.05 to 0.1 pound per pound of wheat material. When steaming materials that do not contain a significant amount or gluten, such as materials of substantially wheat bran or wheat germ, higher amounts of steam can be used, because there is no need to prevent damage to gluten, such as up to 0.5 pounds steam per pound of wheat material, e.g., up to 0.2 pounds of steam per pound of wheat material. The size of the wheat material, e.g., kernels versus flour, may affect the amount of time for contacting a wheat material with steam (e.g., the residence time), but the amount of steam does not necessarily need to be adjusted based on the size of the wheat material.

According to the invention, enzymes in wheat materials have been found to exhibit an increased susceptibility to being deactivated by steam when the enzyme is part of a wheat material having a relatively high moisture content. As such, exposing a low-moisture-content wheat material to steam (e.g., 5 weight percent moisture wheat flour or wheat grain), may normally result in deactivation of a lower percentage of enzymes compared to an identical steam process performed on a wheat material that is otherwise the same but that has a higher moisture content (e.g., 16 weight percent moisture). For this reason, it can be preferred to process a wheat material while the material has a relatively high moisture content, such as a moisture content greater than 10 weight percent.

During steam treatment, a wheat material can achieve an internal temperature that causes deactivation of enzymes. A useful internal temperature can depend on factors such as the internal moisture content of a wheat material. Examples of effective internal temperatures, upon exposure to steam, may be e.g., 66 C, 79 C, or 93 C (150 F, 175 F, or 200 F). As a specific example, wheat material that has from 14 to 15 weight percent moisture may desirably be heated to an internal temperature in the range from 88 C to 91 C (190 F to 195 F). Wheat materials that contain less than a significant amount of gluten, or that are being processed without regard to the possibility of damaging gluten that is present in a significant amount, can be processed to relatively higher internal temperatures, e.g., over 93 C or over 107 C (200 F or over 225 F).

Depending on the type of process and equipment used, e.g., a batch versus a continuous process, a process may optionally include agitation of a wheat material during exposure to steam, and may be performed in stages, e.g., at different temperatures or different pressures if steam is used, if desired or useful.

For flour or other wheat materials that contain a significant amount of gluten, it can be desirable to heat the wheat material quickly and then cool the wheat material quickly, to minimize damage to the gluten. Heating may be accomplished as described, and cooling may be accomplished by known processing techniques and using known equipment, such as by suspension of wheat material using a pneumatic lift, and by similar such equipment and methods.

The amount of enzyme deactivation that can be accomplished by a method of the invention can be an amount that improves the shelf life of a wheat material or a food ingredient or food product prepared from a wheat material processed as described herein. Exemplary amounts of deactivation of enzyme can be at least 30 percent deactivation of the total amount of enzyme originally contained in a wheat material, e.g., deactivation of at least 50 percent of the total amount of enzyme originally contained in a wheat material (as measured in terms of peroxidase). According to certain embodiments of the invention, at least 80 percent, or up to or in excess of 90 or 95 percent of the total enzyme (e.g., as measured in terms of peroxidase) can be deactivated.

In terms of actual peroxidase content of a steam-treated wheat material, various treated wheat materials can be processed to have substantially reduced amounts of active enzymes. One example is steam-treated wheat grain, which can be processed to have less than 4000 units active peroxidase per gram wheat grain, e.g., less than 3000 or 2000 units active peroxidase per gram wheat grain (as is basis). Another example is steam-treated whole wheat flour, which, after processing with steam as described herein, can similarly contain less than 4000 units active peroxidase per gram wheat grain, e.g., less than 3000 or 2000 units active peroxidase per gram wheat grain (as is basis).

Still another example is steam-treated white flour, or milled endosperm of various percentages of endosperm, e.g., at least 70 percent by weight, 80 percent by weight, or in excess of 90 or 95 percent by weight endosperm, depending on the milling process or mill stream. These types of materials, after processing with steam as described herein, can contain reduced amounts of peroxidase relative to their original amounts. Depending on original amounts of peroxidase, such a steam-treated flour material may contain less than 600 units active peroxidase per gram flour, e.g., less than 500 or less than 350, 250 or 200 units active peroxidase per gram flour. As one particular example, a highly pure (e.g., at least 95 percent by weight endosperm) stream of milled wheat comprising low-enzyme endosperm may contain less than 250, 200, or 100 units active peroxidase per gram, following steam treatment as described herein. As a different example, a white flour that includes at least a majority of a ground wheat grain (e.g., 50 percent or 60 percent or more yield (sixty pounds flour per 100 pound milled wheat grain)), sometimes referred to as straight-grade flour, can contain less than 500 units active peroxidase units per gram, e.g., less than 350 or 250 units active peroxidase per gram of flour following treatment with steam as described herein.

According to specific processes of the invention that treat a wheat material that does not include a significant amount of gluten, e.g., wherein the wheat material may not include significant amounts of endosperm, e.g., less than 20 percent by weight endosperm, or less than 3 percent by weight gluten, can be performed at conditions effective to inactivate enzymes, and do not need to be designed to prevent or reduce damage to gluten. These processes can allow a wheat material to be exposed to one or more of a higher steam temperature, a higher amount of steam, or can allow exposure for a longer period of time, allowing for increased deactivation of enzymes. Such processes can on average be effective to inactivate relatively higher amounts of enzymes compared to processes of inactivating enzymes in a gluten-containing wheat material. For example, such processes may deactivate an amount of enzyme in the range of at least 50 percent, up to 80, 90, or 99 percent, of the total amount of enzyme originally present in a wheat material (as measured by peroxidase).

According to other embodiments of the invention, a wheat material for processing may contain greater than an insubstantial amount of gluten, e.g., from 3 to 15 weight percent gluten. According to certain specific embodiments of the invention, treating such as gluten-containing wheat material with steam to deactivate enzymes can be performed in a manner that will leave a desired amount of the original, undamaged, gluten. For example, a wheat material can be processed with steam to inactivate at least a majority of active enzyme as measured by peroxidase, while avoiding damage to a large amount, e.g., a majority, of gluten contained in a wheat material. As a more specific example, at least 30 percent, 50 percent, or in excess of 70 percent of active enzymes may be inactivated, while gluten can be sufficiently undamaged to allow the steam-treated wheat material (e.g., flour or wheat grain) to be used to produce a dough having desired texture and rheology.

A process that avoids substantial damage to gluten can mean that a flour of the gluten-containing wheat material (e.g., a flour that is steam treated or a flour prepared from wheat grain that is steam treated) can be combined with water, without the need for added gluten or other types of flour, to produce a dough that has rheology of a developed dough. This can mean, for example, that the dough can develop as does a developed dough, for example by increasing in viscosity upon mixing. One example of a specific test that can be used to identify a steam-treated wheat material that contains such an amount of undamaged gluten, is rheology testing using a Mixograph. A Mixograph is a machine known in the dough and bread making arts that tests flour for gluten quality and content by measuring the torque produced by mixing a dough prepared from flour and water. When mixing a dough with good quality gluten, the mixer torque will rise to a peak and then decline. When gluten is damaged, the time to reach peak torque, e.g., using a Mixograph, will be extended. When testing flour that has badly damaged gluten, a Mixograph can detect a mixer torque that does not attain a peak. If there is no peak or if the peak time is longer than 20 minutes, the gluten has been badly damaged and the flour will not have good baking functionality, e.g., for developed dough products. Thus, a delayed peak torque can indicate that gluten in a flour has become sufficiently damaged to prevent the flour from providing (by itself) mechanical properties or rheology of a desired dough composition.

More specifically, according to certain embodiments of the invention, gluten-containing flours prepared by treating a flour or wheat grain as described herein, can be combined with water and tested in a Mixograph, and can contain a sufficient amount of undamaged gluten to produce a discernible peak mixing torque as measured by the Mixograph. While a discernible peak may possibly be delayed, if some amount of gluten is damaged, the presence of a discernible peak mixing torque means that the flour contains sufficient undamaged gluten to allow the dough to exhibit a desired rheology. If a dough does not produce a discernible peak mixing torque, or a peak torque occurs at longer than 20 minutes, the dough can be considered to not become developed and to not exhibit this feature of developed dough rheology.

A wheat material that has been processed according to the present description can be used to produce any useful type of food product, such as flour, a dough product or a bread product. Optionally, if desired, other types of flour (e.g., not treated as described herein) may be used in a food or dough composition of the invention, in combination with an amount of the inventive flour.

Flours prepared according to the invention can include reduced amounts of active enzymes, which results in reduced spoilage of the flour and longer shelf life (compared to flours having higher amounts of active enzymes). Also, when a flour of the invention, containing a reduced amount of active enzyme, is included in a food product, the food product can contain a reduced amount of active enzymes, and consequently can also exhibit a longer shelf life compared to food products prepared with other flours having higher amounts of active enzymes.

A dough composition according to the invention, e.g., prepared from a flour or wheat grain that is steamed to deactivate enzymes, can be any type of yeast-leavened or chemically-leavened dough composition. When the steam-treated wheat material includes a substantial amount of gluten (e.g., from 3 to 15 percent by weight) that is not unduly damaged during steam treatment, a flour can be used to prepare a dough composition, such as a developed dough composition.

Developed doughs are generally understood to include doughs that have a developed gluten matrix structure; a stiff, elastic rheology; and that are capable of forming a matrix of relatively elastic bubbles or cells that hold a leavening gas while the dough expands, leavens, or rises, prior to or during cooking (e.g., baking). Features that are sometimes associated with a developed dough, in addition to a stiff, elastic rheology, include a liquid component content, e.g., water content, that is relatively high; a high protein content; a relatively low fat content; and processing steps that include time to allow the dough ingredients (e.g., protein) to interact and “develop” or strengthen the dough. Developed doughs in general can be yeast-leavened or chemically-leavened, and are normally relatively less dense prior to and after cooking (i.e., on average have a relatively higher specific volume) compared to un-developed doughs. Examples of specific types of doughs that can be considered to be developed doughs include doughs for pizza crust, breads (loaves, dinner rolls, baguettes, bread sticks), raised donuts and sweet rolls, cinnamon rolls, croissants, Danishes, pretzels, etc. Examples of baked specific volumes of a developed dough composition can be greater than 2.5 cubic centimeters per gram (cc/g), e.g., from 3 to 6 cc/g.

A wheat material that is processed herein may also be used to produce an un-developed dough composition. In contrast to developed doughs, doughs generally referred to as un-developed (or “non-developed”) have an un-developed matrix structure resulting in a non-elastic rheology and, therefore, relatively lower raw and baked specific volumes due to reduced gas retention by the dough. Examples of un-developed types of doughs include cookies, cakes, cake donuts, muffins, and other batter-type doughs such as brownies, biscuits, etc.

In specific embodiments, a processed wheat material may be wheat grain (kernels) that has a reduced amount and concentration of active enzymes (e.g., at least 30 percent of original peroxidase enzyme is inactivated), and that optionally includes a desirable amount of undamaged gluten. The wheat grain may be further used or processed as desired to produce a food product, such as a milled whole-wheat flour or white flour having reduced enzymes and optionally a high amount of undamaged gluten, for example an amount of undamaged gluten that allows preparation of a dough composition having rheology of a developed dough.

In other embodiments, the processed wheat material may be a bran, germ, or endosperm portion of wheat that has been steamed to reduce the concentration of active enzymes, and that can be further processed as desired, e.g., by combining with other wheat materials to produce a whole-wheat flour, or by combining with another food product.

The invention also includes doughs and dough products prepared using a flour as described herein, e.g., a whole-wheat flour or a white flour. A dough product of the invention may be designed to be leavened by the action of yeast or by the action of a chemical leavening system. A dough product may be refrigerator-stable (e.g., refrigerated), freezer-stable (e.g., frozen), or for immediate use upon preparation. Examples of types of dough products include yeast or chemically leavened dough products such as developed breads including refrigerated or frozen bread doughs, bread sticks, bagels, baguettes, raised donuts, croissants, etc.; as well as less-developed dough products including refrigerated or frozen biscuits, rolls, cookies, batters, muffins, Danishes, cake donuts; or any other known or developed dough products that includes a flour ingredient.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the included claims.

### Method of Measuring Peroxidase

### Principle:

Peroxidase Catalyzes the Following Reaction:

Donor+H₂O₂→oxidized donor+H₂O

Guaiacol is a suitable donor for colorimetric detection of peroxidase; the oxidized form (tetraguaiacol) is highly colored with an absorbance peak at ˜435 nm.

### Method:

Peroxidase enzyme is extracted from a sample of wheat material using 0.015-0.020 M ammonium acetate and centrifuged. An aliquot of the supernatant is reacted with alcoholic guaiacol (10% v/v) and 3% hydrogen peroxide. The absorbance at λ=435 is measured; the increase in absorbance is proportional to the activity of peroxidase. Peroxidase U/g (i.e. “units”/gram) is defined as the increase in absorbance over a 1-hour period (at room temperature, 22 C-23 C (72 F-73 F)) multiplied by approximately 670 and divided by the sample weight (in grams).

### REFERENCES

1. Whitaker, J.; Voragen, A.; Wong, D. Handbook of Food Enzymology, pp. 403-411. 2003, Marcel Dekker, Inc.
2. Bergmeyer, H. U. Methods of Enzymatic Analysis: Enzymes, vol. 2, 2^{nd} ed., pp. 685-690. 1985, Wiley-VCH.
3. Vamos-Vigyazo, L. CRC Critical Reviews in Food Science and Nutrition, pp. 84-127. 1981, CRC Press.
4. Varoquaux, P.; Clochard, A.; Sarris, J.; Avisse, C.; Morfeauz, J. N. 1975. Lebensmittel Wissenshaft und Technologie 8:60 (in French).

### EXAMPLE 1

Wheat grain was treated by passing through a twin screw extruder with steam injection and no die. Temperature and moisture for the wheat entering the extruder were 21 C (70 F) and 10.8%. Temperature and moisture for the wheat exiting the extruder were 81 C (177 F) and 16.7 weight percent moisture. Residence time in the extruder was 21 seconds. After exiting the extruder the wheat was immediately cooled and dried by passing through 2 pneumatic lifts. Temperature and moisture of the wheat after the second pneumatic lift were 36 C (97 F) and 13.7 weight percent moisture.

Flour was milled from the steamed wheat and the original, control wheat.

Biscuit doughs were mixed from the steamed wheat flour from the control wheat flour, and from commercially milled flour. Doughs were put into cans. At 2, 4, 6, and 8 weeks after dough mixing, cans of dough were baked into biscuits. Biscuits from the steamed wheat flour have consistently had better volume, shape, and texture than biscuits made from the other flours.

### EXAMPLE 2

Wheat grain was treated with steam by passing through a Clextral twin screw extruder as follows:

Screw configuration with all forward conveying elements, no mixing elements

100 rpm screw speed

wheat description: hard red winter, protein=12.2%, moisture=11.8%

wheat feed rate: 10 lb/min

steam injection rate: 46 lb/hour

average residence time in twin screw: 21 sec

wheat temperature at screw exit: 92 C (197 F)

wheat moisture at screw exit: 16.4%

after exiting the extruder, the wheat was sent to a pneumatic lift

wheat temperature after first pneumatic lift: 49 C (120 F)

wheat moisture after first pneumatic lift: 14.1%

after exiting the first pneumatic lift, the wheat was sent to a second pneumatic lift.

wheat temperature after 2nd pneumatic lift: 39 C (102 F)

wheat moisture after 2nd pneumatic lift: 13.6%

Flour was milled from the steamed wheat and the original, control wheat.

The control (non-heat-treated wheat) had 4750 units peroxidase/g. After heating, the wheat peroxidase was 920 units/g. Flour milled from the treated wheat had 170 units peroxidase/g and a Mixograph peak time of 13.6 min. Flour milled from the control (un-treated) wheat had 390 units/g peroxidase and a 5.0 minute Mixograph peak time.

Biscuit doughs were mixed from the steamed wheat flour from the control wheat flour, and from commercially milled flour. Doughs were put into cans. At 2, 4, 6, and 8 weeks after dough mixing, cans of dough were baked into biscuits. Biscuits from the steamed wheat flour have consistently better volume, shape, and texture, compared to biscuits made from the other flours.

### EXAMPLE 3

White wheat flour was treated with steam by passing through a Buhler twin screw extruder as follows:

screw configuration with 3 mixing elements, otherwise all forward conveying elements

1390 rpm screw speed

flour description: hard red winter, protein=11.9%, moisture 13.1%

flour feed rate: 10 lb/min

steam feed rate: 50 lb/hr

average residence time in twin-screw: 0.8 sec

flour temperature at screw exit: 91 C (195 F)

after exiting the twin screw, the flour goes into a pneumatic lift

flour temperature after pneumatic lift: 34 C (94 F)

flour moisture after pneumatic lift: 14.2%

The control (untreated) flour had 610 units/g peroxidase and a 4.98 minute Mixograph peak time. The same flour after heat treatment had 390 units/g peroxidase and a Mixograph peak time of 11.72 min.

### EXAMPLE 4

### Whole-Wheat Flour—Bran Heating

A general milling method to prepare whole-wheat flour includes first milling the wheat on the conventional mill, which produces streams of a flour portion (i.e., white flour containing mostly endosperm) and a “bran portion” containing fine bran, coarse bran, and shorts. The fine bran and coarse bran are ground on a hammermill. All streams are then combined to make a whole wheat flour. According to an exemplary method of the invention, we obtained separate amounts of the white flour and bran portion as prepared in making whole wheat flour as described. The fine bran and coarse bran had been ground on a hammermill. According to the invention, the “bran portion” was steamed in the kettle kiln (modified Groen kettle) as follows.

### Bran Steaming Procedure

The “bran portion” was the combination of ground bran and shorts as used to make whole wheat flour described immediately above. It included all mill streams except 10 the white flour. The relative amounts by weight were 24.9 wt. % bran portion and 75.1 wt. % of flour. The Groen kettle had a net capacity of about 4 cubic feet, a steam jacket and has been modified to have steam injection into the product.

1. Turn on kettle kiln jacket steam and set jacket temperature to 177 C (350 F).
2. Pour 75 lb of bran into kettle kiln and start agitator.
3. After 5 minutes, turn on injection steam at 100 C (212 F) (1.5 lbs. of steam per minute). Run injection steam for 25 minutes.
4. Continue jacket steam (at 177 C (350 F)) for 30 more minutes, then turn off.
5. Run agitator about 20 more minutes, then remove bran from kettle kiln.

### Flour, Bran (Un-Steamed and Steamed), and Whole Wheat Flour Data

| | | Ground bran | | Whole wheat | Whole wheat |
|---|---|---|---|---|---|
| | White flour | prior to | Steamed | flour from | flour from |
| | portion | steaming | bran portion | blend of | blend of |
| Description | (A) | (B) | (C) | A and B | A and C |
| Percent untreated flour | 100 | — | — | 75.10% | 75.27% |
| Percent non-steam-treated bran | — | 100 | — | 24.90% | — |
| Percent steam treated bran | — | 100 | — | — | 24.73% |
| moisture (%) | 13.30% | 11.00% | 10.18% | 11.80% | 12.30% |
| Peroxidase (units/g, 14% mb) | 1746 | 25124 | 153 | 6689 | 1177 |

1. A method of processing a wheat material, the method comprising
providing a wheat material that contains endosperm and active enzyme, and
treating the wheat material by contact with steam to deactivate enzymes without substantially damaging gluten of the endosperm.

2. The method of claim 1 wherein the wheat material has a moisture content in the range from 10 to 16 percent, when treated.

3. The method of claim 1 wherein the wheat material is wheat grain or wheat flour and the method comprises contacting the wheat grain or wheat flour with steam at a rate of 0.05 to 0.1 pound of steam per pound of wheat grain or wheat flour.

4. The method of claim 1 wherein the wheat material is selected from wheat grain, whole wheat flour, and white flour.

5. The method of claim 1 wherein the wheat material is white flour, and the treated white flour has less than 500 units active peroxidase per gram.

6. The method of claim 1 wherein the wheat material is whole wheat flour and the treated whole wheat flour has less than 4000 units active peroxidase per gram.

7. The method of claim 1 wherein the wheat material is wheat grain, the method comprising
treating the wheat grain with from 0.05 to 0.1 pound of steam per pound of wheat grain, the steam being at approximately atmospheric pressure, for a time in the range from 10 to 30 seconds, and
milling the steam-treated wheat grain to produce a wheat flour.

8. The method of claim 1 wherein the wheat material is wheat grain, the method comprising
milling the treated wheat grain to produce straight-grade white wheat flour, wherein the flour contains less than 350 units active peroxidase per gram.

9. The method of claim 1 wherein the wheat material is wheat grain, the method comprising
milling the treated wheat grain to produce whole wheat flour, wherein the whole wheat flour contains less than 4000 units active peroxidase per gram.

10. A method of processing wheat material, the method comprising
providing wheat material that contains enzymes, and
treating the wheat material with steam to deactivate enzymes.

11. The method of claim 10 wherein the wheat material is selected from the group consisting of wheat grain, sprouting wheat grain, wheat bran, wheat germ, wheat endosperm, wheat flour, and combinations thereof.

12. The method of claim 10 wherein the wheat material has a moisture content in the range from 10 to 16 percent.

13. A method of processing wheat material, the method comprising
providing a wheat material comprising greater than 10 percent by weight moisture, and
contacting the wheat material with from 0.05 to 0.5 pounds of steam per pound of wheat material, the steam being at approximately atmospheric pressure.

14. A low enzyme whole-wheat flour containing less than 4000 units active peroxidase per gram.

15. A low enzyme white wheat flour containing less than 250 units active peroxidase per gram.

16. A low enzyme straight-grade white wheat flour containing less than 350 units active peroxidase per gram.
